(19) United States
(12) Patent Application Publication
(10) Pub. No.: US 2005/0096409 A1
(43) Pub. Date: May 5, 2005

(54) Ink composition and method for use thereof in the manufacturing of electrochemical sensors

(76) Inventors: Oliver William Hardwicke Davies, Croy (GB); Robert Marshall, Inverness (GB); Thomas Joseph O'Reilly, Farr (GB); Darren Iain Mitchell, Inverness (GB); Emma-Louise Robertson, Culloden (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/495,208

(22) PCT Filed: Oct. 30, 2003
(86) PCT No.: PCT/GB03/04690

(51) Int. Cl. C03C 17/00; C09D 5/00

(52) U.S. Cl. 523/160; 523/161

(57) ABSTRACT

An ink composition for manufacturing electrochemical sensors in accordance with the present invention includes graphite, carbon black, a resin and at least one solvent (e.g., at least one solvent with a boiling point between 120° C. and 250° C.). The ink composition has a weight ratio of graphite to carbon black is in a range of from 4:1 to 1:4 and a weight ratio of a sum of graphite and carbon black to resin in a range of from 10:1 to 1:1. Also, a method for manufacturing an electrochemical sensor includes transporting a substrate web past at least one print station and printing at least one electrochemical sensor electrode on the substrate web at the print station(s). The printing is accomplished by applying an ink composition to substrate web, wherein the ink composition includes, graphite, carbon black, a resin and at least one solvent. In addition, weight ratio of graphite to carbon black in the ink composition is in a range of from 4:1 to 1:4 and a weight ratio of a sum of graphite and carbon black to resin is in a range of from 10:1 to 1:1.

### BACKGROUND OF THE INVENTION

1. Field of the Invention

The present invention relates, in general, to ink compositions and their associated methods and, in particular, to ink compositions for use in manufacturing electrochemical sensors and their associated methods.

2. Description of the Related Art

### SUMMARY OF THE INVENTION

An exemplary embodiment of an ink composition for manufacturing electrochemical sensors in accordance with the present invention includes graphite, carbon black, a resin and at least one solvent (e.g., at least one solvent with a boiling point between 120° C. and 250° C.). The ink composition has a weight ratio of graphite to carbon black in a range of from 4:1 to 1:4 and a weight ratio of a sum of graphite and carbon black to resin in a range of from 10:1 to 1:1.

An exemplary embodiment of a method for manufacturing an electrochemical sensor according to the present invention includes transporting a substrate web past at least one print station and printing at least one electrochemical sensor electrode on the substrate web at the print station(s). The printing is accomplished by applying an ink composition to substrate web. The ink composition which is applied includes graphite, carbon black, a resin and at least one solvent. In addition, a weight ratio of graphite to carbon black in the ink composition is in a range of from 4:1 to 1:4 and a weight ratio of a sum of graphite and carbon black to resin is in a range of from 10:1 to 1:1.

### BRIEF DESCRIPTION OF DRAWINGS

A better understanding of the features and advantages of the present invention will be obtained by reference to the following detailed description that sets forth illustrative embodiments, in which the principles of the invention are utilized, and the accompanying drawings of which:

FIG. 1 is a flow chart illustrating a sequence of steps in a process according to an exemplary embodiment of the present invention.

### DETAILED DESCRIPTION OF THE INVENTION

Once apprised of the present disclosure and the disclosure of provisional patent application No. 60/436,683, which is hereby fully incorporated by reference, one skilled in art will recognize that a variety of ink compositions (also referred to as inks or carbon inks) can be utilized in processes for manufacturing electrochemical sensors (e.g., web-based processes according to the aforementioned provisional patent application). However, ink compositions according to embodiments of the present invention are based on the recognition that it is particularly desirable to employ ink compositions that (i) provide for a printed electrode of a manufactured electrochemical sensor to possess beneficial electrochemical and physical characteristics (such as, for example, electrochemical characteristics that are essentially equivalent to those provided by a batch manufacturing process and/or a desirable overpotential, electrochemical surface area, resistance, capacitance, and stability) and (ii) is compatible with relatively high-speed continuous web processing techniques.

For an ink composition to be compatible with high-speed continuous web processing techniques, the ink composition should be dryable in a drying duration (time) that does not limit the speed of the continuous web process (e.g., a short drying duration in the range of 30 seconds to 60 seconds). Such a short drying duration requires more severe (harsher) drying conditions (e.g., the use of 140° C. air at a velocity of 60 m³/minute) than a conventional batch process. Unfortunately, when such severe drying conditions are used, there is a tendency for the surface of conventional ink compositions to bum and/or for a portion of a conventional ink composition that is in contact with a substrate to remain undried. Furthermore, the combination of severe drying conditions and conventional ink compositions can result in the formation of an electrode (e.g., a carbon electrode) with undesirable electrochemical characteristics. Therefore, conventional ink compositions typically require the use of relatively slow drying conditions and a relatively long drying duration (e.g., approximately 15 or more minutes).

It has been unexpectedly determined that ink compositions according to the present invention, which include graphite, carbon black, a resin and one or more organic solvents, are particularly useful in the manufacturing of electrochemical sensors. Ink compositions according to the present invention provide for a printed electrode of a manufactured electrochemical sensor to possess beneficial electrochemical and physical characteristics. The ink compositions are also compatible with relatively high-speed continuous web processing techniques. This compatibility is due to the relatively high conductivity of the ink compositions, which enables a thinner printed film (i.e., printed electrode). In addition, it is postulated without being bound that the printed electrode is easily dried due to its thin nature and the use of an ink composition that includes at least one solvent of an appropriate boiling point.

The graphite, carbon black and resin percentages of ink compositions according to the present invention are predetermined such that a weight ratio of graphite to carbon black is in the range from 4:1 to 1:4 and a weight ratio of the sum of graphite and carbon black to resin is in the range of from 10:1 to 1:1. Factors which can influence optimization within of the aforementioned ratios are the resulting electrochemical surface area, overpotential for oxidizing a redox mediator, as well as the stability, resistance, and capacitance of a printed carbon film (e.g., carbon electrode).

It is envisioned that ink compositions according to the present invention can be used to manufacture carbon films that serve as electrochemical sensor electrodes. Such carbon films can be used in an electrochemical glucose biosensor, wherein a current is measured at a constant potential and the magnitude of the measured current is indicative of a glucose concentration. The resulting current can be linearly calibrated to output an accurate glucose concentration. A method of calibrating electrochemical glucose biosensors is to define multiple calibration codes within a calibration space, in which a particular calibration code is associated with a discrete slope and intercept pair. For a particular lot of electrochemical sensors, a measured current output may be mathematically transformed into an accurate glucose concentration by subtracting an intercept value from the measured current output and then dividing by the slope value.

It should be noted that the measured current output, slope and intercept values can be influenced by the electrochemical surface area, overpotential for oxidizing a redox mediator, as well as the stability, resistance, and capacitance of the carbon film that serves as the electrochemical sensor electrode. Therefore, the weight ratio of graphite to carbon black and weight ratio of the sum of graphite and carbon black to resin can be optimized to provide a desired range of slopes and intercepts.

Any suitable graphite and carbon black known to one skilled in the art can be employed in ink compositions according to the present invention. In this regard, a carbon black with a surface area of, for example, 20 to 1000 m²/g is generally suitable in terms of providing a requisite conductivity. In general, the conductivity of the carbon black increases with the its surface area and a relatively high conductivity carbon black can be beneficial in terms of providing desirable electrochemical characteristics. Other characteristics of carbon black that are desirable for use in the present invention are high conductivity, low sulfur content, low ionic contamination and easy dispersability. Suitable carbon blacks include, but are not limited to, Vulcan XC-72 carbon black (available from Cabot) and Conductex 975B carbon black (available from Sevalco). Other types of carbon of carbon black that may be suitable for the present invention are Black Pearls (available from Cabot), Elftex (available from Cabot), Mogul (available from Cabot), Monarch (available from Cabot), Emperor (available from Cabot), Regal (available from Cabot), United (available from Cabot), and Sterling (available from Cabot), Ketjen Black International Company (available from Ketjen Black), Mitsubishi Conductive Carbon Black (available from Mitsubishi Chemical), Shawinigan Black (available from Chevron Phillips Chemical Company LP) and Conductex® (available from Columbian Chemicals Company). Suitable graphites include, but are not limited to, Timrex KS15 carbon (available from G&S Inorganics). The particle size of graphite can be, for example, between 5 and 500 μm, but more preferably can be 15 μm. Other types of graphite that may be suitable for the present invention are Timrex KS6 to Timrex KS500 where the number following the term KS represent the particle size in units of microns. Other characteristics of graphite that are desirable for use in the present invention are high conductivity, low ash content, low sulfur content and low inorganic impurities.

In general, the surface area of graphite is much less than the surface area of carbon black by virtue of graphite's non-porous nature. For example, the surface area of Timrex KS15 is approximately 12 m²/g. It is theorized without being bound that the use of graphite in ink compositions according to the present invention enhances the electron transfer properties of electrodes manufactured using the ink compositions. However, an optimized weight percentage of carbon black is needed in the ink composition in order to increase the overall conductivity of the ink composition. Otherwise, the use of graphite alone would result in a film having a very high electrode resistance.

The electrochemical surface area of a carbon electrode may represent the portion of the carbon electrode that can contribute to the oxidation of mediator. Graphite, resin and carbon black can have varying degrees of conductivity and, thus, influence the proportion of the geometric electrode area that can participate in the oxidation of a mediator. The geometric electrode area represents the area of a carbon electrode that is exposed to a liquid sample. Since the electrode material (i.e., an ink composition used to manufacture an electrode) can have an insulating resin therein, the electrochemical area may be smaller than the geometric area. In general, the current output of a glucose biosensor is directly proportional to the electrochemical surface area. Therefore, variations in the electrochemical surface area may influence the slope and intercept of the glucose biosensor.

The stability of a carbon electrode is important in designing robust glucose biosensors which are useful to diabetic users. In general, stability of a carbon electrode can be optimized by choosing an appropriate resin and ensuring that sufficient solvent is removed from the carbon electrode during drying. It is possible that insufficiently dried carbon electrode can outgas solvent during its storage and thus cause a change in the performance of the resulting glucose biosensor. Furthermore, the stability of the carbon electrode may influence the slope and intercept of the glucose biosensor.

The resistance and capacitance are intrinsic properties of a carbon electrode and are strongly dependent of the proportions of carbon black, graphite, and resin within the carbon electrode. For example, the resistance of a carbon electrode will increase when a higher proportion of resin or graphite is used in the electrode's formulation. The resistance of an electrode may influence the electrochemical current of a glucose biosensor because of the uncompensated IR drop between a reference electrode and a working electrode. The capacitance of an electrode will depend on the ability of an ionic double layer to form at an electrode/liquid interface. The formation of such an ionic double layer will influence the magnitude of the measured current. Certain proportions of carbon black, graphite, and resin are likely to enhance the ability of the ionic double layer to form. Therefore, the resistance and capacitance of a carbon electrode can influence the slope and intercept of a glucose biosensor.

With respect to an electrochemical sensor of a glucose measuring system that includes a working electrode, it is desirable that a relatively low potential be applied to the sensor's working electrode in order to minimize the effect of oxidizable interferences that are often endogenous to physiological samples. To achieve such a relatively low potential, it is beneficial that the material from which the working electrode is formed enables the oxidation of ferrocyanide (or other redox mediator) at the lowest possible potential. This can be achieved, for example, by minimizing the activation energy required for electron transfer between the working electrode and ferrocyanide (or other redox mediator). In this regard, it has been determined that the ratio of graphite to carbon black is critical in defining (e.g., minimizing) the overpotential required for the oxidation of a reduced redox mediator such as, for example, ferrocyanide by an electrode of the electrochemical sensor.

For the above reason, ink compositions according to the present invention have a ratio of graphite to carbon black that is in the range of from 4:1 to 1:4. Furthermore, a particularly beneficial ratio of graphite to carbon black in terms of defining the overpotential has been determined to be 2.62:1. It has also been determined that the ratio of the sum of graphite and carbon black to resin also influences the overpotential for oxidizing reduced redox mediator such as, for example, ferrocyanide. And it is for this reason that the ratio of the sum of graphite and carbon black to resin is in a range of from 10:1 to 1:1, with a particularly beneficial ratio being 2.9:1.

The resin employed in ink compositions according to the present invention can be any suitable resin known to one skilled in the art including, but not limited to, terpolymers that comprise vinyl chloride, vinyl acetate and vinyl alcohol. One such terpolymer is VAGH resin available from Union Carbide. Resin is employed in the ink composition as a binding agent and to help adhere carbon black and graphite to a substrate (such as web substrate) during the manufacturing of an electrochemical sensor. Additionally, resins such as VAGH will provide flexibility to the printed film, which is especially useful in a continuous web based processes where printed films must be stable when rewound into a roll format.

The at least one solvent that is included in ink compositions according to the present invention is a solvent in which the resin is soluble and which has, for example, a boiling point in the range of 120° C. to 250° C. It is desirable that the boiling point not be less than 120° C. in order to insure that rapid bubbling does not occur in a printed ink composition film when the film is exposed to a drying temperature of 140° C. Such rapid bubbling during the drying process could cause the printed films (i.e., printed electrodes) to have a rough surface which may be undesirable. If a solvent's boiling point is greater than 250° C., there is a risk that the ink composition will not sufficiently dry when exposed to, for example, a drying temperature of 140° C. and an air flow of 60 m³/min for a duration in the range of approximately 30 seconds to 60 seconds.

Suitable solvents include, for example, a combination of methoxy propoxy propanol (bis-(2-methoxypropyl) ether), isophorone (3,5,5-trimethyl-2-cyclohenex-1-one) and diacetone alcohol (4-hydroxy-4-methyl-2-pentanone). It should be noted that a combination of at least two solvents can be particularly beneficial because of a possible decrease in boiling point of the aggregate solvent mixture, i.e., azeotrope mixture. The use of isophorone alone can provide a carbon ink composition with favorable electrical properties. However, the combination of isophorone with methoxy propoxy propanol and diacetone alcohol can accelerate the drying of the carbon ink. Once apprised of the present disclosure, one of skill in the art can choose other suitable solvents with drying properties that are appropriate to various drying conditions.

Ink compositions according to the present invention have several beneficial properties including being fast-drying while providing for the manufacturing of an electrode with desirable physical and electrochemical properties. The ink compositions can be dried quickly using relatively severe conditions and are, therefore, compatible with high-speed continuous web-based processing techniques. In addition, the ink compositions also enable the manufacturing of highly conductive carbon electrodes even when a relatively thin coating (e.g., a coating with a thickness in the range of 5 microns to 20 microns, for example 10 microns) of the ink composition is employed. Furthermore, the ink compositions are of low toxicity, bind well to substrate layers (and to insulating layers), possess a good print quality and long screen life (i.e., the ink composition does not solidify when used for a long period in screen printing), and are of low cost.

Ink compositions according to the present invention can be prepared using any suitable ink preparation technique, including techniques that are well known to those of skill in the art. In one embodiment of the invention, the weight % of solids is in the range of 36 to 44% and the weight % of solvent is in the range of 56 to 64%. One factor which helps control the quality and thickness of an ink composition is viscosity. It should be noted that the weight % of solids influences the viscosity of the ink. In one embodiment of the current invention, the ink composition has a viscosity between 11 to 25 Pascal seconds at 50 RPM, and between 21 to 43 Pascal seconds at 10 RPM (25° C.). Experimentally, it was found that inks with a weight % of solids in the range of 36% to 44% resulted in glucose biosensors having a relatively constant calibration slope when preparing glucose biosensors using such inks (see graph below). It is possible that the more robust calibration slopes was a result of a more uniform electrode thickness resulting from the optimized viscosity.

[image]

Carbon ink can be made, for example, by first dissolving 9.65 g of VAGH in an organic solvent made up of 46.53 g of methoxy propoxy propanol, 7.90 g of isophorone and 7.89 g of diacetone alcohol in a closed vessel. Next, 7.74 g of carbon black is added to the mixture and then mixed in the closed vessel. 20.29 g of graphite is then added to the mixture, followed by mixing in the closed vessel. In order to ensure sufficient homogenization, a triple roll milling is performed on the mixture followed by more mixing.

Another embodiment of an ink composition ink composition for use in manufacturing electrochemical sensors according to the present invention includes (i) between approximately 17 and 21% by weight of graphite; (ii) between approximately 6.5 and 8.0% by weight of carbon black; (iii) between approximately 12.4 to 15.2% by weight of a terpolymer resin that includes vinyl chloride, vinyl acetate and vinyl alcohol; and (iv) between approximately 55.8 to 64.1% by weight of a solvent mixture that includes isophorone, diacetone alcohol and methoxy propoxy propanol.

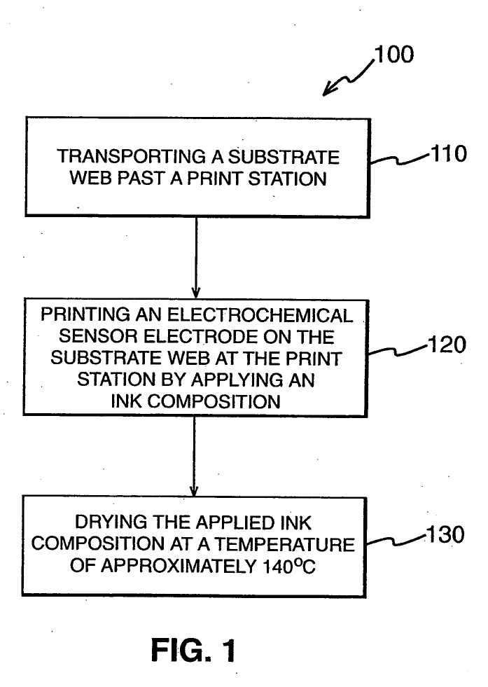

The ink composition, as well as the ink compositions described above, can be employed in the manufacturing of electrochemical sensors by a variety of processes including, but not limited to, those described in Provisional Patent Application No. 60/436,683. In this regard and referring to FIG. 1, a process 100 for manufacturing an electrochemical sensor includes transporting a substrate web past at least one print station (as set forth in step 110) and printing at least one electrochemical sensor electrode on the substrate web at the print station(s). The printing is accomplished by applying an ink composition according to the present invention as described above to the substrate, as set forth in step 120. As illustrated at step 130, process 100 also includes a step of drying the ink composition that has been applied to the substrate at temperature of approximately 140° C. with an airflow of 60 m³/min. In one embodiment of the invention, substrate web speed may be 10 m/min

Once apprised of the present disclosure, one skilled in the art will recognize that processes according to the present invention, including process 100, can be accomplished using methods described in Provisional Patent Application No. 60/436,683, which is hereby incorporated in full by reference.

It should be understood that various alternatives to the embodiments of the invention described herein may be employed in practicing the invention. It is intended that the following claims define the scope of the invention and that structures and methods within the scope of these claims and their equivalents be covered thereby.

1. An ink composition for use in manufacturing electrochemical sensors, the ink composition comprising:
graphite;
carbon black;
a resin; and
at least one solvent;
wherein a weight ratio of graphite to carbon black is in a range of from 4:1 to 1:4; and
wherein a weight ratio of a sum of graphite and carbon black to resin is in a range of from 10:1 to 1:1.

2. The ink composition of claim 1, wherein the solvent has a boiling point between 120° C. and 250° C.

3. The ink composition of claim 1, wherein the solvent includes of isophorone, diacetone alcohol and methoxy propoxy propanol.

4. The ink composition of claim 1, wherein the resin is a terpolymer that includes vinyl chloride, vinyl acetate and vinyl alcohol.

5. The ink composition of claim 1, wherein the ratio of graphite to carbon black is approximately 2.62:1 and the ratio of the sum of graphite and carbon black to resin is approximately 2.9:1.

6. The ink composition of claim 1, wherein a particle size of the graphite is approximately 15 microns.

7. A method for manufacturing an electrochemical sensor, the method comprising:
transporting a substrate web past at least one print station; and
printing at least one electrochemical sensor electrode on the substrate at the print station by applying an ink composition to substrate, wherein the ink composition comprises:
graphite;
carbon black;
a resin; and
at least one solvent;
wherein a weight ratio of graphite to carbon black is in a range of from 4:1 to 1:4; and
wherein a weight ratio of a sum of graphite and carbon black to resin is in a range of from 10:1 to 1:1.

8. The method of claim 7 further comprising:
drying the ink composition that has been applied to the substrate at temperature of approximately 140° C.

9. The method of claim 7 further comprising:
drying the ink composition that has been applied to the substrate with an air flow of 60 m³/min.

10. The method of claim 7, wherein the drying step has a duration in a range of 30 seconds to 60 seconds.

11. The method of claim 7, wherein the solvent has a boiling point between 120° C. and 250° C.

12. The method of claim 7, wherein the solvent includes of isophorone, diacetone alcohol and methoxy propoxy propanol.

13. The method of claim 7, wherein the resin is a terpolymer that includes vinyl chloride, vinyl acetate and vinyl alcohol.

14. The method of claim 7, wherein the ratio graphite to carbon black is approximately 2.62:1 and the ratio is approximately 2.9:1.

15. The method of claim 7, wherein a particle size of the graphite is approximately 15 microns.

16. The method of claim 7, wherein the transporting and printing steps are accomplished using a continuous web-based process.
